(19) United States
(12) Patent Application Publication
(10) Pub. No.: US 2006/0097876 A1
(43) Pub. Date: May 11, 2006

(54) Secure mobile container, in particular an airplane cabin cart

(76) Inventors: Dominique Retali, Le Perreux (FR); Peter Kovacs, Budapest (HU)

Correspondence Address: BIRCH STEWART KOLASCH & BIRCH, PO BOX 747, FALLS CHURCH, VA, 22040-0747, US

(21) Appl. No.: 11/200,206

(22) Filed: Aug. 10, 2005

(30) Foreign Application Priority Data
Nov. 8, 2004 (FR) 04 08814

(51) Int. Cl. G08B 13/14

(52) U.S. Cl. 340/572.1

(57) ABSTRACT

The invention relates to a mobile container fitted with a management module comprising a memory and: a break-in detection member for detecting attempts at breaking into the mobile container, the management module being adapted to store time-and-date stamped break-in information in the memory on each occasion that the break-in detection member detects a break-in or an attempted break-in; and a first communications module for dialoguing with a terminal and connected to the memory to send the break-in information stored in the memory to the terminal as soon as communication is set up with the terminal. The container is also fitted with a second communications module suitable for dialoguing with radio frequency labels carried by articles contained in the container.

The invention relates to a secure mobile container, in particular an airplane cabin cart.

### BACKGROUND OF THE INVENTION

Mobile containers are known that make it convenient to transport smaller articles brought together inside a singe. container; mention can be made of containers for receiving a set of postal articles sent to a common distribution point, or indeed containers for receiving the various items of baggage belonging to passengers of a single flight, and making it easier to handle the baggage as a whole.

In particular, cabin carts or trolleys are known for containing articles such as perfumes or cigarettes, such carts being moved by cabin crew in order to offer the articles for sale to passengers.

Managing the contents of such mobile containers poses a certain number of problems, including handling break-ins or attempted break-ins to which the containers are sometimes subjected between leaving a restocking storeroom and being taken in charge at a destination, or indeed practical difficulties associated with taking inventories of their contents, throughout the time they are in use.

### OBJECT OF THE INVENTION

The invention seeks to provide a mobile container fitted with means enabling such attempts at break-ins to be identified, and where appropriate, enabling inventories to be taken of the contents of the container.

### SUMMARY OF THE INVENTION

A mobile container is proposed which, according to the invention, is fitted with a management module including a memory and:
a break-in detection member for detecting attempts at breaking into the mobile container, the management module being adapted to store time-and-date stamped break-in information in the memory on each occasion that the break-in detection member detects a break-in or an attempted break-in; and
a first communications module for dialoguing with a terminal and connected to the memory to send the break-in information stored in the memory to the terminal as soon as communication is set up with the terminal.

Break-in information is thus delivered as quickly as possible to the terminal, either immediately if a call was already in progress, or else as soon as such a call can be set up. The attempted break-in is then relayed very quickly so that staff responsible for the container can immediately take the appropriate measures.

According to a particular aspect of the invention, the container contains articles carrying radio frequency labels, and the management module has a second communications module for dialoguing with the radio frequency labels in order to take an inventory of the articles, the second communications module being connected to the memory in order to write inventory information therein in response to an inventory-taking order, whereas in response to an inventory-taking instruction coming from the terminal, the first communications module is adapted to send the inventory information stored in the memory to the terminal.

Thus, an inventory of the contents of the mobile container is taken automatically using the second communications module and the inventory can be transmitted directly to a personal digital assistant of a person in charge, e.g. the chief steward when the container is a cart on board an airplane. The chief steward can thus determine at all times and without waiting what is contained in the mobile container. In particular, without needing to open the cart, the chief steward can take an inventory on taking charge of the cart, and can compare that inventory with an inventory taken on leaving the storeroom, thus making it possible to detect immediately if any articles have disappeared between the storeroom and the airplane.

### BRIEF DESCRIPTION OF THE DRAWING

The invention will be better understood in the light of the following description of a cabin cart for use on board an airplane, given with reference to the accompanying figures, in which:
FIG. 1 is a diagrammatic perspective view of a cabin cart of the invention; and
FIG. 2 is a block diagram of the management module fitted to the FIG. 1 cart.

### DETAILED DESCRIPTION OF THE INVENTION

The invention is described herein in its application to cabin carts to trolleys of the kind used in airplanes for offering various articles (perfumes, cigarettes, watches, . . .) for sale to passengers.

As shown in FIG. 1, such a cart comprises a structure 1 defining an enclosure 2 for receiving a certain number of articles 3 (only one is referenced). The cart has wheels 4 enabling it to be moved and a door 5 for closing the enclosure 2 to prevent access to the articles contained therein.

The door 5 is fitted with a lock 6 enabling the door 5 to be locked when it is in the closed position, either automatically or by applying an electrical pulse, and to unlock the door 5 in response to another electrical pulse.

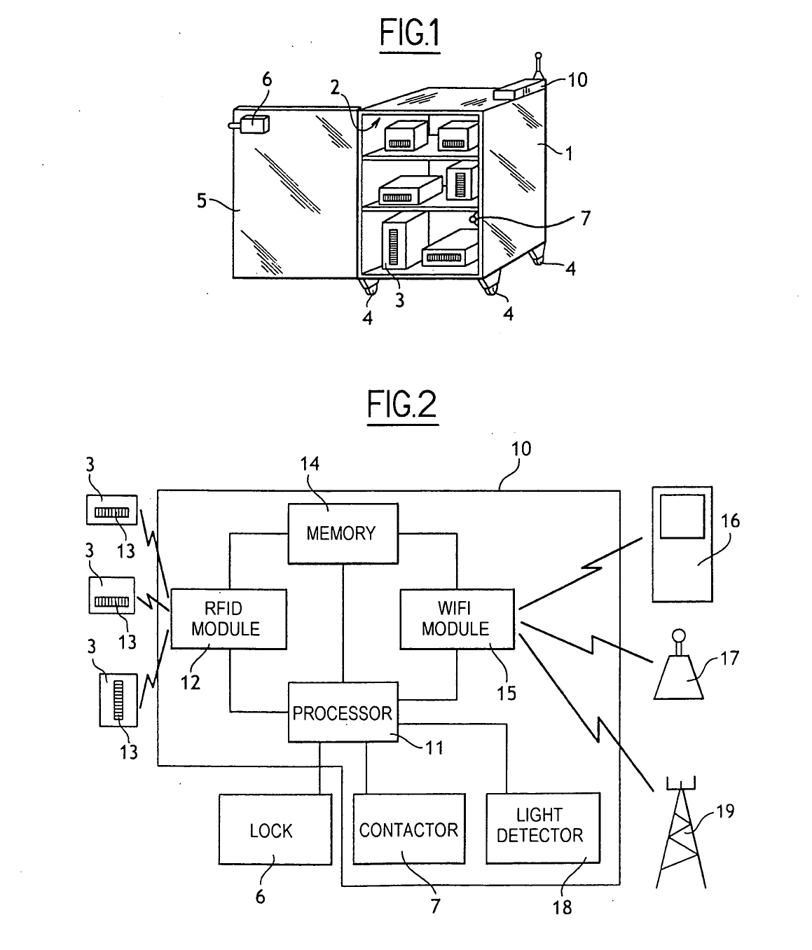

According to the invention, the cart is fitted with a management module 10 described in detail below with reference to FIG. 2.

The management module 10 firstly comprises a processor 11 adapted to run a program for managing the cart.

The management module 10 also comprises a first communications module 15, e.g. using WiFi technology, enabling the management module 10 to dialog with a remote terminal, such as a personal digital assistant (PDA) 16 belonging to the chief steward, a terminal 17 of a storeroom for restocking carts, or indeed a local network 19 in an airport. The first communications module 15 enables the processor 11 to receive various instructions coming from the outside, and serves to transmit the content of a memory 14 to which the first communications module 15 is connected.

The management module includes a light detector 18 placed inside the enclosure and connected to the processor 11. The processor 11 is programmed to record in the memory 14 break-in information with a time-and-date stamp on each occasion that the light detector 18 detects light inside the cart while the door 5 is not supposed to be open. The light detector makes it possible to detect a wall of the cart being torn open, a wall being removed, or indeed the door being deformed while it is closed and locked.

The management module 10 also has a second communications module 12, e.g. employing radio frequency identification data (RFID) technology suitable for communicating remotely with radio frequency (RF) labels 13 carried by the articles 3, using the following procedure: on receiving an inventory-taking order issued by the processor 11, the second communications module 12 emits a radio signal which is received by all of the labels 13 present inside the cart. In response, each label 13 emits an identification (ID) radio signal that is specific to the article with which the label is associated. All of the ID signals emitted by the labels 13 are received by the second communications module 12 which is configured to generate an inventory file listing the contents of the cart and to store the inventory file in the memory 14 of the management module 10.

The processor 11 is also connected to the lock 6 so that on each occasion an electrical pulse is sent to the lock 6 by the processor, the processor 11 stores unlocking time-and-date stamp information in the memory 14.

The management module 10 includes a contactor 7 placed on the cart in such a manner as to be in a closed state when the door 5 is in its closed position, and in an open state when the door 5 is not in its closed position. The processor 11 is connected to the contactor 7 so that on each transition of the contactor from a closed state to an open state, the processor 11 stores time-and-date stamp information concerning the opening of the door 5 in the memory 14.

The cart management module operates as follows.

After the cart has been re-stocked in the storeroom, an inventory is taken on going past the terminal 17 of the storeroom.

Before the cart is brought to the airplane in which it is to be loaded, the cart is generally parked in a waiting area. A certain amount of time can thus elapse between the moment when the cart is restocked and the moment when the chief steward takes it in charge, and this can be conducive to an attempted break-in.

In the event of a break-in or an attempted break-in, date-and-time stamped break-in information is immediately written into the memory 14 by the processor 11 in response to the light detector 18 detecting light, and the first communications module 15 verifies whether a call is in progress. If so, break-in information is immediately sent to the terminal with which a call is already established. Otherwise, the break-in information is sent as soon as call setup is detected, e.g. with the airport local network 19, which can be programmed to continuously monitor waiting carts at the airport.

Thus, the cart of the invention itself raises the alarm as quickly as possible. The personnel concerned can then react immediately by intervening to stop the break-in if that is still possible, or at least to observe that the break-in has indeed occurred and to what extent, e.g. for the purpose of taking remedial action before the cart is taken on board.

The cart is then taken into the charge of the chief steward. The door 5 of the cart is closed and locked. The chief steward establishes remote contact with the management module 10 by means of the PDA 16. The inventory of the cart that was drawn up on leaving the re-stocking storeroom and stored in the memory 14 is then transferred to the chief steward's PDA 16. A new inventory is made by the chief steward and compared with the inventory made on leaving the storeroom. This comparison between the two inventories enables the chief steward to determine whether any articles have disappeared between leaving the storeroom and being taken on board the airplane.

In this respect, if there is any doubt, the chief steward can also read the information concerning opening and closing of the door 5 as stored in the memory 14 and can verify whether the cart has been opened between leaving the storeroom and the moment when it was taken on board the airplane. The steward can also verify whether there has been attempt at a break-in, since the break-in information is automatically sent by the first communications module 15 to the steward's PDA 16 as soon as a call is set up.

Before beginning service with passengers, the chief steward causes the door 5 of the cart to be unlocked.

For this purpose, the steward sends an unlocking instruction to the management module 10.

The processor 11 sends an electrical pulse to the electromagnet of the lock 6, thereby unlocking the door 5. The cart is then ready to be used by cabin crew for selling articles to passengers.

Authorized opening of the door 5 causes the light detector 8 to be inhibited so as to avoid break-in information being written in the memory 14.

When the cart is returned after sales to passengers have been completed, the chief steward closes the door 5 of the cart, if this has not already been done, and the door locks automatically. By means of the contactor 7, the processor 11 is informed that the door 5 is closed, and it issues an order to the first communications module 12 to take an inventory. An inventory file is then generated and stored in the memory 14. The inventory file is then transmitted to the PDA 16 of the chief steward via the second communications module 15 which reads the inventory file directly from the memory 14.

By comparing the initial inventory taken when the cart came on board with the final inventory, the chief steward is informed about the articles that have been sold and can deduce directly therefrom the turnover that has been generated by such sales.

This comparison also makes it possible to make provision for restocking the cart, and a list can be sent to the restocking storeroom in order to prepare new stock.

As soon as the door is closed, the light detector 18 is reactivated.

At the end of the flight, the cart is off-loaded and taken to the storeroom to be restocked. The terminal 17 at the restocking storeroom makes contact remotely with the management module 10 of the cart. The cart is identified and associated with the corresponding new stock which has already been prepared.

The terminal 17 sends an unlocking instruction to the door 5 so that the storage room staff can refill the cart. Once it has been refilled, the door 5 is closed and locked.

The processor 11 then sends an inventory order to the first communications module which generates an inventory file on leaving the storage room, and this file is stored in the memory 14.

It should be observed that it is possible at all times to send an inventory instruction to the management module 10 so as to cause an inventory of the contents of the cart to be taken, with the corresponding inventory file being sent to the remote terminal that issued the instructions.

The invention is not limited to the particular embodiment described above, but on the contrary covers any variant coming within the ambit of the invention as defined by the claims.

In particular, although the invention is described herein in its application to a mobile cart for use in a cabin, it can also apply to other mobile containers for receiving articles, and capable of being fitted with communications modules suitable for dialoguing with an external terminal.

Although the first communications module is described as enabling dialog to be undertaken between the management module of the mobile container and remote terminals such as a PDA, a storage room terminal, or a local network in an airport, the first communications module could enable a dialog to be undertaken with other remote terminals such as the computer on board an airplane or management terminals of the airline.

Although instructions to control the mobile container (lock/unlock, inventory, transfer memory contents) are described as coming exclusively from a remote terminal, the cart may be fitted with a keyboard or a touch-sensitive screen so as to enable instructions to be issued without having recourse to a remote terminal. Under such circumstances, it is desirable to make provision for a code for obtaining access to the terminal.

In a variant to the inventory procedure being triggered automatically by the locking instruction, it is also possible to envisage that it is the unlocking instruction that triggers an inventory to be taken automatically before the container is actually opened. Nevertheless, it is more convenient to take an inventory on locking the door, particularly if the inventory-taking cycle is relatively long.

Although the door position detector is shown as being a simple contact, the detector could make use of other technologies, for example an optical or a magnetic sensor.

Although the above description refers to light being detected inside the cart in order to identify attempted break-ins, it would also be possible to detect impacts, or any other kind of action taken on the cart.

Although the cart shown is fitted with means giving selective access to the articles, i.e. a door having a lock, the means giving selective access could comprise a grid with a controlled latch or drawers containing the articles and suitable for being locked in the closed position.

What is claimed is:

1. A mobile container fitted with a management module including a memory and:
a break-in detection member for detecting attempts at breaking into the mobile container, the management module being adapted to store time-and-date stamped break-in information in the memory on each occasion that the break-in detection member detects a break-in or an attempted break-in; and
a first communications module for dialoguing with a terminal and connected to the memory to send the break-in information stored in the memory to the terminal as soon as communication is set up with the terminal.

2. A mobile container according to claim 1, wherein the break-in detection member comprises a light detector disposed inside the container.

3. A mobile container according to claim 1, containing articles carrying radio frequency labels, the management module including a second communications module for dialoguing with the radio frequency labels in order to take an inventory of the articles, and connected to the memory in order to write inventory information therein in response to receiving an order to take an inventory, the first communications module also being adapted to send the inventory information stored in the memory to the terminal in response to receiving an inventory-taking instruction from the terminal.

4. A mobile container according to claim 1, including selective access means adapted to be locked in a position for preventing access to the articles, and wherein the management module is configured to send an inventory-taking order to the second communications module in response to receiving an instruction to lock the access means.

5. A mobile container according to claim 4, wherein the locking instruction comes from the terminal.

6. A mobile container according to claim 1, including a detector for detecting the presence of the selected access member in the position for preventing access, and wherein the management module is adapted to write date-and-time stamp information in the memory on each occasion that the detector detects that the selective access member leaves or returns to the access-preventing position.
